(19) United States
(12) Patent Application Publication
(10) Pub. No.: US 2006/0165340 A1
(43) Pub. Date: Jul. 27, 2006

(54) Thermo-optic waveguide device and manufacturing method thereof

(75) Inventor: Yuying Wu, Matsudo-shi (JP)

Correspondence Address: BLANK ROME LLP, 600 NEW HAMPSHIRE AVENUE, N.W., WASHINGTON, DC, 20037, US

(73) Assignee: Seikoh Giken Co., Ltd., Matsudo-shi (JP)

(21) Appl. No.: 11/338,697

(22) Filed: Jan. 25, 2006

(30) Foreign Application Priority Data
Jan. 26, 2005 (JP) P2005-017735

(51) Int. Cl. G02F 1/295; G02B 6/26; G02B 6/42; B29D 11/00; G02B 6/10

(52) U.S. Cl. 385/5; 385/4; 385/39; 385/40; 385/129; 385/130; 385/132; 264/1.24

(57) ABSTRACT

A thermo-optic waveguide device of a low cost, with low power consumption and low thermal stress, and having excellent mass-productivity, and a manufacturing method thereof are provided. The thermo-optic waveguide device includes, on a substrate, an optical waveguide and a thin-film heater that exerts a thermo-optic effect on the optical waveguide. The thermo-optic waveguide device further includes a thermal separation groove arranged substantially in parallel with an optical waveguide core along at least one side of the optical waveguide core corresponding to the thin-film heater. In the manufacturing method of the thermo-optic waveguide device, the thermal separation groove arranged near the optical waveguide core is formed together with the optical waveguide, in a process of forming the optical waveguide on the substrate by using a photopolymer.

### CROSS-REFERENCE TO RELATED APPLICATION

This application is based upon and claims the benefit of priority from the prior Japanese Patent Application No. 2005-017735, filed on Jan. 26, 2005; the entire contents of which are incorporated herein by reference.

### BACKGROUND OF THE INVENTION

1. Field of the Invention

The present invention relates to a thermo-optic waveguide device including, on a substrate, an optical waveguide and a thin-film heater that exerts a thermo-optic effect on the optical waveguide, and a manufacturing method of the thermo-optic waveguide device.

2. Description of the Related Art

In general, optical waveguide devices using the thermo-optic effect are widely used for optical devices such as an optical switch, a variable optical attenuator (VOA), and an optical sensor, used in optical communication systems and optical transmission systems. The thermo-optic effect is a phenomenon in which the refractive index of an optical waveguide material changes due to heating.

A thermo-optic switch uses an optical waveguide formed of a material having the thermo-optic effect, and switches an optical output port by energizing a conductive thin-film heater to change the refractive index of the optical waveguide.

A thermo-optic VOA uses an optical waveguide formed of a material having the thermo-optic effect, and attenuates an output optical power by controlling electric power flowing in the conductive thin-film heater to change the refractive index of the optical waveguide.

Recently, with the popularization of the optical communication system and the optical transmission system, it is required to reduce the cost, save electric power, and realize large-scale integration of such optical devices. Therefore, research and development regarding the optical waveguide using a photopolymer instead of the conventional optical waveguide using a silica glass are under way.

Since the photopolymer has a thermo-optic coefficient larger by one digit or more than that of an inorganic material such as the silica glass, the photopolymer can form optical devices that can be operated at a lower heating temperature than in the case of using the silica glass. Furthermore, to operate the optical devices with good responsiveness, an optical waveguide material having a high thermal conductivity can be used. When a material having a good thermal conductivity is used, transfer of heat to a waveguide core, which is an object to be heated, is facilitated. At the same time, however, heat transfer to peripheral waveguides, which are not objects to be heated, is also facilitated, thereby causing a problem in effective use of heat.

Furthermore, if the waveguides, including those which are not to be heated, are heated, heat capacity required for temperature rise increases, thereby causing a problem in that heating time and switching speed of the optical devices are limited. Furthermore, if a target waveguide core is heated, thermo-optic effect is generated, but thermal expansion also occurs. At this time, since thermal expansion coefficients of the polymer waveguide and of a silicon wafer are different from each other by one digit or more, an upper cladding layer of the waveguide elongates due to thermal expansion simultaneously with generation of a compressive force acting on a lower cladding layer from a silicon substrate. Due to the interaction thereof, uneven stress is applied to the waveguide core, to cause birefringence of the core, thereby causing a problem of deterioration in polarization property, extinction ratio, and the like of the optical device.

In a waveguide optical device of a type controlling an optical path of light by heating a part of the optical waveguide, which uses the photopolymer, heat is accumulated by repeated operation, and local distortion occurs to deteriorate the optical characteristics such as the extinction ratio.

To solve such problems, it has been conventionally proposed to provide a thermal separation groove for preventing transfer of heat near an optical waveguide core where a heater is formed. Such an optical switch is disclosed in Japanese Patent Application Laid-Open Nos. 2004-85744 and 2004-309927.

The conventional method of providing the thermal separation groove, however, has following problems, since the groove is formed by cutting or dry etching or the like after the optical waveguide is formed.

That is, when the thermal separation groove is formed by cutting after formation of the optical waveguide, it is difficult to form a groove having a constant depth. Furthermore, in a case that a waveguide having a complicated pattern is formed in a high density, formation of the groove itself is difficult, and a groove of an optional shape other than a linear groove cannot be formed.

For example, in the case of the optical switch disclosed in Japanese Patent Application Laid-Open No. 2004-85744, there are problems such as shape accuracy and position accuracy of the groove, and lack of mass-productivity to form the thermal separation groove by cutting with a saw or a cutting tool with an interval of several tens micrometers from the waveguide core of several micrometers on the large-scale integrated waveguide wafer.

When the thermal separation groove is formed by dry etching or the like after the formation of the optical waveguide, machining equipment becomes expensive.

For example, in the case of the optical waveguide device disclosed in Japanese Patent Application Laid-Open No. 2004-309927, since dry etching is carried out after forming the optical waveguide, an expensive machining apparatus is required, thereby increasing the machining cost of the optical devices.

### SUMMARY OF THE INVENTION

The present invention has been achieved in order to solve the above problems. It is one object of the present invention to provide a thermo-optic waveguide device of a low cost, with low power consumption and low thermal stress, and having excellent mass-productivity, and a manufacturing method thereof.

To achieve the object, according to one aspect of the present invention, there is provided a thermo-optic waveguide device including, on a substrate, an optical waveguide and a thin-film heater that exerts a thermo-optic effect on the optical waveguide, having a thermal separation groove arranged substantially in parallel with an optical waveguide core along at least one side of the optical waveguide core corresponding to the thin-film heater.

According to another aspect of the present invention, there is provided a thermo-optic waveguide device, wherein the thermal separation groove is formed with a depth in which a surface of the substrate is exposed substantially.

According to another aspect of the present invention, there is provided a thermo-optic waveguide device, wherein the thermal separation groove is formed on the substrate together with the optical waveguide, by using a photopolymer capable of patterning by photolithographic processing

According to another aspect of the present invention, there is provided a thermo-optic waveguide device including, on a substrate, a plurality of selectable optical waveguides and a thin-film heater that exerts a thermo-optic effect selectively on these optical waveguides, having a thermal separation groove arranged along an optical waveguide core corresponding to the thin-film heater, in an area between the optical waveguide cores, in a branch section where the optical waveguide is substantially branched to at least two optical waveguides

According to another aspect of the present invention, there is provided a thermo-optic waveguide device, wherein the thermal separation groove is formed with a depth in which a surface of the substrate is exposed substantially.

According to another aspect of the present invention, there is provided a thermo-optic waveguide device, wherein the thermal separation groove is formed on the substrate together with the optical waveguide, by using a photopolymer capable of patterning by photolithographic processing.

According to another aspect of the present invention, there is provided a thermo-optic waveguide device including, on a substrate, an optical waveguide and a thin-film heater that exerts a thermo-optic effect on the optical waveguide, having a thermal separation groove having a depth in which a surface of the substrate is exposed substantially, and arranged near an optical waveguide core corresponding to the thin-film heater.

According to another aspect of the present invention, there is provided a thermo-optic waveguide device, wherein the thermal separation groove is formed on the substrate together with the optical waveguide, by using a photopolymer capable of patterning by photolithographic processing.

According to another aspect of the present invention, there is provided a manufacturing method of a thermo-optic waveguide device including, on a substrate, an optical waveguide and a thin-film heater that exerts a thermo-optic effect on the optical waveguide, wherein in a process of forming the optical waveguide by using a photopolymer on a substrate, a thermal separation groove to be arranged near an optical waveguide core is formed together with the optical waveguide.

According to another aspect of the present invention, there is provided a manufacturing method of a thermo-optic waveguide device including, on a substrate, an optical waveguide and a thin-film heater that exerts a thermo-optic effect on the optical waveguide, having at least a process of forming a lower cladding layer including a thermal separation groove by applying a photopolymer for cladding on the substrate and by performing photolithographic processing where the thermal separation groove arranged substantially in parallel with an optical waveguide core corresponding to the thin-film heater is patterned along the optical waveguide core.

According to another aspect of the present invention, there is provided a manufacturing method of a thermo-optic waveguide device including, on a substrate, an optical waveguide and a thin-film heater that exerts a thermo-optic effect on the optical waveguide, having at least a process of forming a lower cladding layer including a thermal separation groove by applying a photopolymer for cladding on the substrate and by performing photolithographic processing where the thermal separation groove arranged substantially in parallel with an optical waveguide core corresponding to the thin-film heater is patterned along the optical waveguide core; a process of forming the core by applying a photopolymer for the core on the lower cladding layer and by performing photolithographic processing where the core is patterned; and a process of forming an upper cladding layer including the thermal separation groove by applying a photopolymer for cladding on the lower cladding layer and the core, and by performing photolithographic processing where the thermal separation groove is patterned.

According to another aspect of the present invention, there is provided a manufacturing method of a thermo-optic waveguide device including, on a substrate, an optical waveguide and a thin-film heater that exerts a thermo-optic effect on the optical waveguide, having a process of forming a lower cladding layer including a thermal separation groove by applying a photopolymer for cladding on the substrate and by performing photolithographic processing where the thermal separation groove arranged substantially in parallel with an optical waveguide core corresponding to the thin-film heater is patterned along the optical waveguide core; a process of forming the core by applying a photopolymer for the core on the lower cladding layer and by performing photolithographic processing where the core is patterned; a process of forming an upper cladding layer including the thermal separation groove by applying a photopolymer for cladding on the lower cladding layer and the core, and by performing photolithographic processing where the thermal separation groove is patterned; and a process of forming the thin-film heater on the optical waveguide including the thermal separation groove.

According to still another aspect of the present invention, there is provided a manufacturing method of a thermo-optic waveguide device, further having a process of forming a coupling layer for increasing adhesiveness between the substrate and the lower cladding layer, before the process of forming the lower cladding layer.

### BRIEF DESCRIPTION OF THE ACCOMPANYING DRAWINGS

These and other objects and the configuration of this invention will become clearer from the following description of the preferred embodiments, read in connection with the accompanying drawings in which:

FIG. 1 is a schematic cross section showing a thermo-optic waveguide device according to a first embodiment of the present invention;

FIGS. 2A, 2B, and 2C are schematic cross sections showing a process of forming a lower cladding layer including a thermo separation groove in the first embodiment of a manufacturing method of the thermo-optic waveguide device according to the present invention;

FIGS. 3A, 3B, and 3C are schematic cross sections showing a process of forming a core;

FIGS. 4A, 4B, and 4C are schematic cross sections showing a process of forming an upper cladding layer including the thermo separation groove;

FIG. 5 is a schematic cross section showing a process of forming a thin-film heater;

FIG. 6 is a schematic cross section showing a process of forming a coupling layer, in the second embodiment of a manufacturing method of the present invention;

FIG. 7 is a schematic cross section showing a process of forming the lower cladding layer including the thermo separation groove;

FIG. 8 is a schematic cross section showing a process of forming the core;

FIG. 9 is a schematic cross section showing a process of forming the upper cladding layer including the thermo separation groove;

FIG. 10 is a schematic cross section showing a process of forming the thin-film heater;

FIG. 11 is a plan view of a Y-branch waveguide (1×2) optical switch formed by using the thermo-optic waveguide device according to the second embodiment of the present invention;

FIG. 12 is a cross section along line XII-XII in FIG. 11;

FIG. 13 is a plan view of a Mach-Zehnder (MZ) interference (2×2) optical switch formed by using a thermo-optic waveguide device according to a third embodiment of the present invention;

FIG. 14 is a cross section along line XIV-XIV in FIG. 13;

FIG. 15 is a plan view of a Mach-Zehnder (MZ) interference variable optical attenuator (VOA) formed by using a thermo-optic waveguide device according to a fourth embodiment of the present invention; and

FIG. 16 is a cross section along line XVI-XVI in FIG. 15.

### DETAILED DESCRIPTION OF THE INVENTION

Embodiments of the present invention will be described with reference to the drawings.

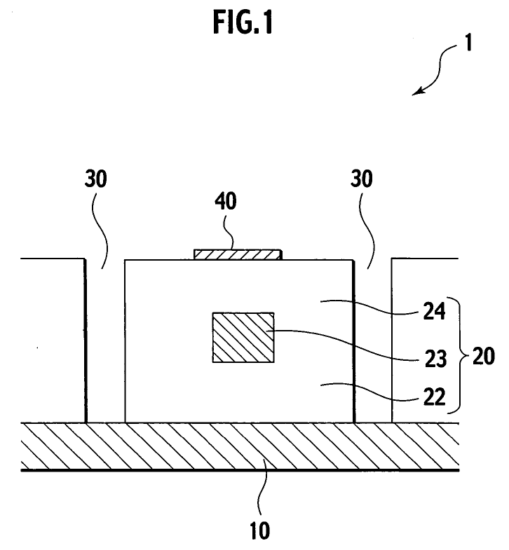

FIG. 1 shows a thermo-optic waveguide device according to a first embodiment of the present invention. A thermo-optic waveguide device 1 includes, on a substrate 10, an optical waveguide 20 and a thin-film heater 40 that exerts a thermo-optic effect on the optical waveguide 20.

The thermo-optic waveguide device 1 includes a thermal separation groove 30 arranged substantially in parallel with an optical waveguide core 23 (see FIGS. 11, 13, and 15) along at least one side of the optical waveguide core 23 corresponding to the thin-film heater 40, and preferably along both sides of the optical waveguide core 23.

The thermo-optic waveguide device 1 is arranged, as shown in FIG. 1, near the optical waveguide core 23 opposite to the thin-film heater 40, preferably arranged along the optical waveguide core 23, and includes the thermal separation groove 30 having a depth in which a surface of the substrate 10 is substantially exposed.

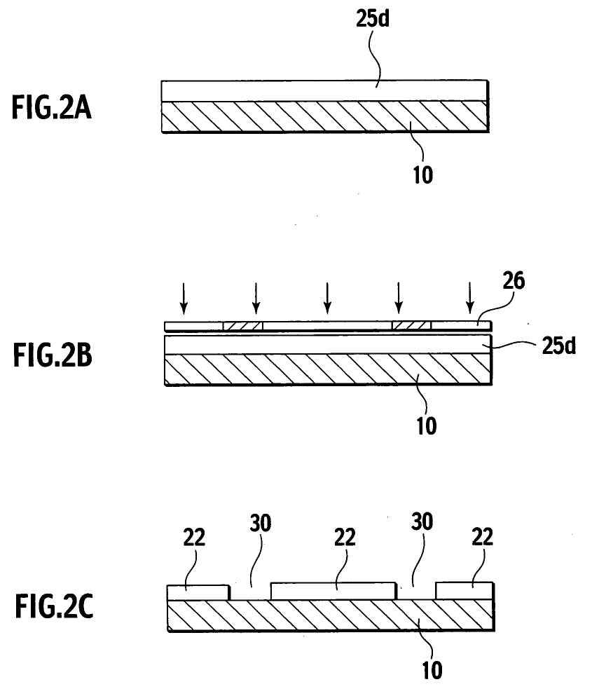

FIGS. 2 to 5 show the first embodiment of a manufacturing method of the thermo-optic waveguide device 1 according to the present invention. The manufacturing method of the thermo-optic waveguide device is a first method for manufacturing the thermo-optic waveguide device 1 shown in FIG. 1.

That is, according to the manufacturing method of the thermo-optic waveguide device, when the thermo-optic waveguide device 1 is to be manufactured, the optical waveguide 20 and the thermo separation groove 30 arranged near the optical waveguide core 23 are formed simultaneously on the substrate (silicon substrate) 10, in a process of forming the optical waveguide 20 by using a photopolymer 25.

The manufacturing method of the thermo-optic waveguide device is explained in order of process. At first, a photopolymer 25d for cladding is applied on the silicon substrate 10, to form a lower cladding layer 22 including the thermo separation groove 30, by photolithographic processing in which the thermo separation groove is patterned (see FIGS. 2A, 2B, and 2C).

Specifically, the photopolymer 25d for cladding is applied on the silicon substrate 10, for example, by using a spin coat method (see FIG. 2A).

Subsequently, the applied photopolymer 25d is exposed from above by using a photomask 26 in which a thermo separation groove pattern to be arranged substantially in parallel with the optical waveguide core 23 is formed along the optical waveguide core 23 corresponding to the thin-film heater 40 (see FIG. 2B).

The exposed photopolymer 25d is developed and baked (see FIG. 2C). As a result, as shown in FIG. 2C, the lower cladding layer 22 including the thermo separation groove 30 is formed.

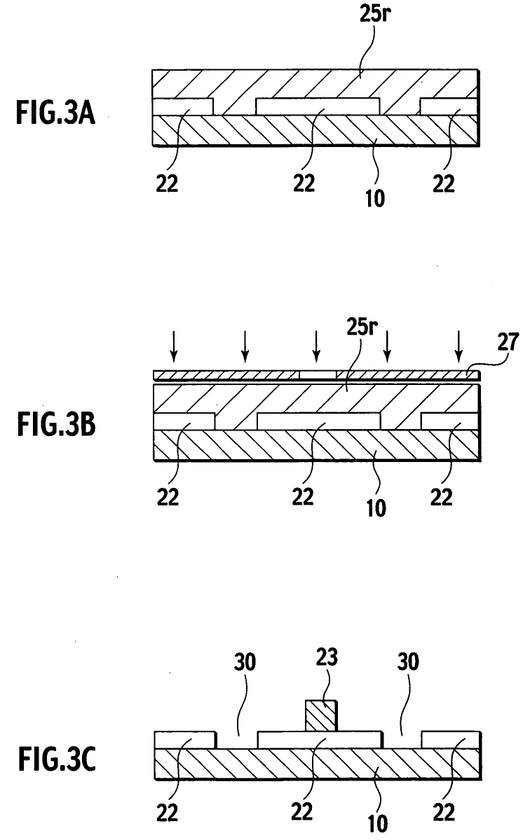

A photopolymer 25r for the core having a larger refractive index than that of the photopolymer 25d for cladding is applied on the lower cladding layer 22, to form the core 23 by photolithographic processing in which the core is patterned (see FIGS. 3A, 3B, and 3C).

Specifically, the photopolymer 25r for the core is applied on the lower cladding layer 22 formed on the silicon substrate 10, for example, by using the spin coat method (see FIG. 3A).

The applied photopolymer 25r is then exposed from above by using a photomask 27 in which a core pattern is formed (see FIG. 3B).

The exposed photopolymer 25r is developed and baked (see FIG. 3C). As a result, as shown in FIG. 3C, the core 23 is formed.

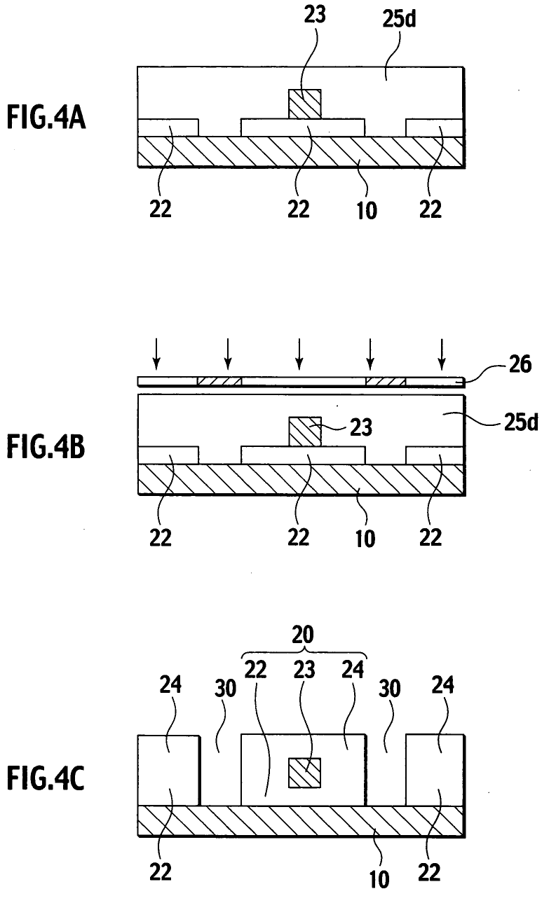

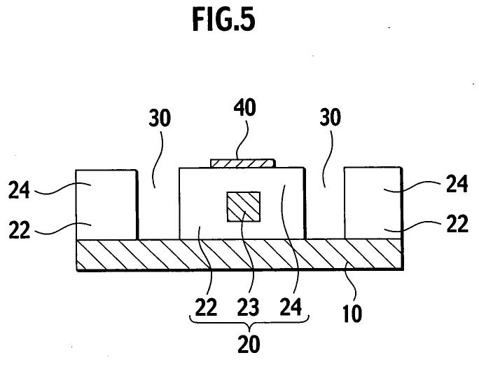

A photopolymer 25d for cladding is applied on the lower cladding layer 22 and the core 23 to form an upper cladding layer 24 including the thermo separation groove 30 by photolithographic processing in which the thermo separation groove is patterned (see FIGS. 4A, 4B, and 4C).

Specifically, the photopolymer 25d for cladding is applied on the lower cladding layer 22 and the core 23 formed on the silicon substrate 10, for example, by using the spin coat method (see FIG. 4A).

The applied photopolymer 25d is then exposed from above by using the same photomask 26 used with reference to FIG. 2B, in which the thermo separation groove pattern is formed (see FIG. 4B).

The exposed photopolymer 25d is developed and baked (see FIG. 4C). As a result, as shown in FIG. 4C, the upper cladding layer 24 including the thermo separation groove 30 is formed.

As a result, the optical waveguide 20 integrally including the lower cladding layer 22, the core 23, and the upper cladding layer 24 is formed, with the thermo separation grooves 30 formed on the both sides thereof.

Lastly, the thin-film heater 40 is formed on the optical waveguide 20 including the thermo separation grooves 30 (see FIG. 5).

As one method for forming the thin-film heater 40, a conductive metallic material is first deposited on the optical waveguide 20 including the thermo separation groove 30 shown in FIG. 4C, for example, by using a sputtering method. Then, a photoresist is applied thereon, for example, by using the spin coat method, and exposure and patterning are performed by using a photomask in which a heater pattern is formed. A metal film at unnecessary parts is removed by wet etching, using the thus formed resist film as a mask, and lastly, the resist film on the heater pattern is pealed, thereby obtaining the thin-film heater 40.

As another method for forming the thin-film heater 40, a photoresist is applied on the optical waveguide 20 including the thermo separation groove 30 shown in FIG. 40C, for example, by using the spin coat method, and exposure and patterning are performed by using a photomask in which a heater pattern is formed. A conductive metallic material is deposited on the resist film, on which the thus formed heater pattern is opened, for example, by using the sputtering method, and the resist film is lifted off, thereby obtaining the thin-film heater 40 remaining in the opening.

The photopolymer 25 (photopolymers 25d and 25r) is a transparent material suitable for forming the optical waveguide and capable of patterning by alkali development according to the photolithographic processing. Specifically, the photopolymer 25 is selected from, for example, epoxy, polyimide, fluorinated polyimide, polysilane, sol-gel, acrylic resins, silicone resin, and polysiloxane.

The conductive metallic material used for forming the thin-film heater 40 is selected from metals or alloys such as Cr, Ni, Pt, and Au. Methods such as sputtering, vacuum evaporation, and plating can be used for depositing the thin-film heater 40. The photolithographic processing such as photoresist, wet etching, and dry etching can be used for pattering of the thin-film heater 40.

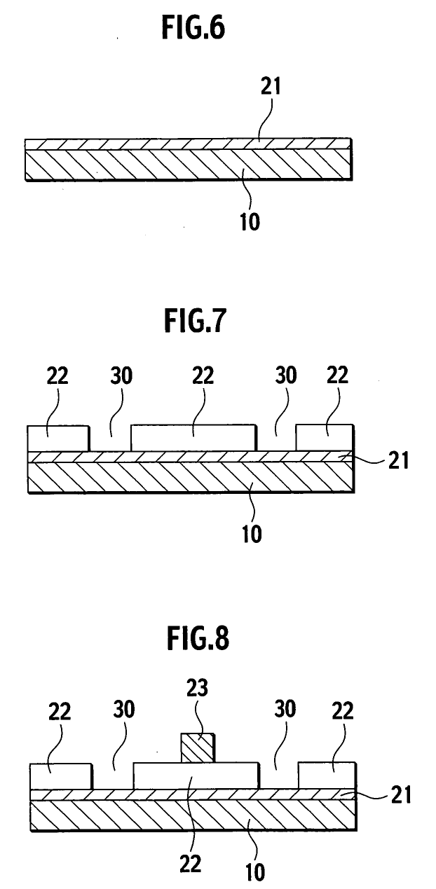

FIGS. 6 to 10 show the second embodiment of a manufacturing method of the thermo-optic waveguide device 1 according to the present invention. The manufacturing method of the thermo-optic waveguide device is a second method for manufacturing the thermo-optic waveguide device 1 shown in FIG. 1.

That is, according to the manufacturing method of the thermo-optic waveguide device, when the thermo-optic waveguide device 1 is to be manufactured, the optical waveguide 20 and the thermo separation groove 30 arranged near the optical waveguide core 23 are formed simultaneously on the substrate (silicon substrate) 10, in the process of forming the optical waveguide 20 by using the photopolymer 25.

The manufacturing method of the thermo-optic waveguide device is explained in order of process. At first, a coupling layer 21 that increases adhesiveness between the silicon substrate 10 and the lower cladding layer 22 is formed on the substrate 10 (see FIG. 6).

The photopolymer 25d for cladding is applied on the coupling layer 21 on the silicon substrate 10 to form the lower cladding layer 22 including the thermo separation groove 30 by photolithographic processing in which the thermo separation groove is patterned (see FIG. 7).

The forming process of the lower cladding layer 22 including the thermo separation groove 30 is the same as that shown in FIGS. 2A, 2B, and 2C, and hence, the specific explanation and illustration of the process are omitted.

The photopolymer 25r for the core is applied on the lower cladding layer 22 to form the core 23 by the photolithographic processing in which the core is patterned (see FIG. 8).

Since the forming process of the core 23 is the same as that shown in FIGS. 3A, 3B, and 3C, the specific explanation and illustration of the process are omitted.

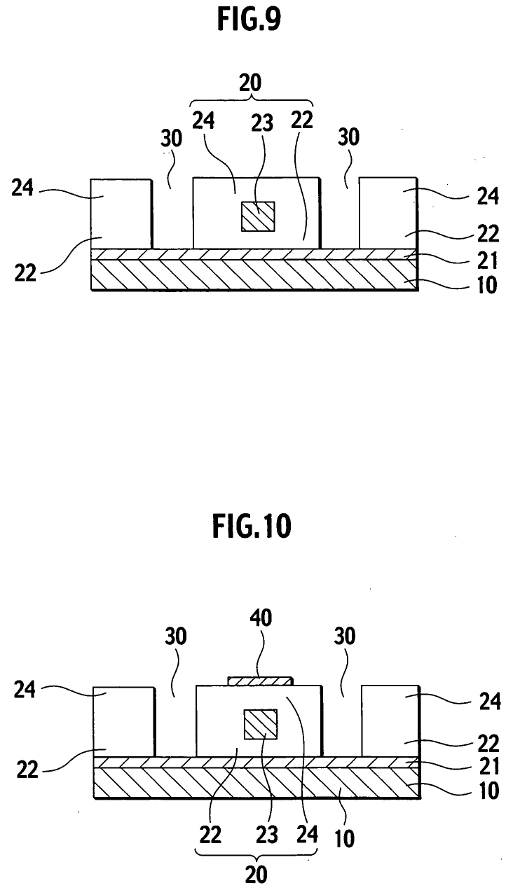

The photopolymer 25d for cladding is applied on the lower cladding layer 22 and the core 23 to form the upper cladding layer 24 including the thermo separation groove 30 by the photolithographic processing in which the thermo separation groove is patterned (see FIG. 9).

Since the forming process of the upper cladding layer 24 including the thermo separation groove 30 is the same as that shown in FIGS. 4A, 4B, and 4C, the specific explanation and illustration of the process are omitted.

Lastly, the thin-film heater 40 is formed on the optical waveguide 20 including the thermo separation groove 30 by the photolithographic processing in which the heater is patterned (see FIG. 10).

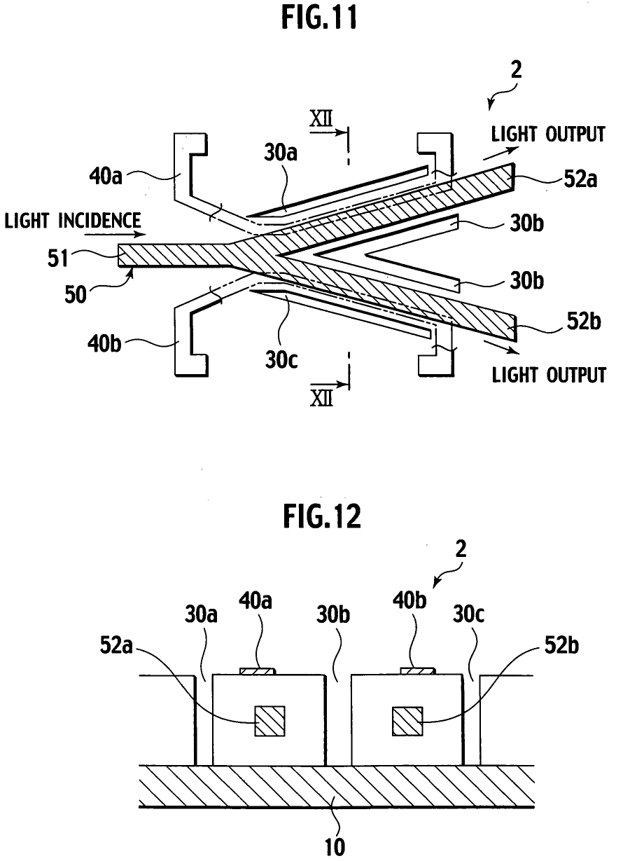

FIGS. 11 and 12 show the thermo-optic waveguide device according to the second embodiment of the present invention. FIG. 11 is a plan view of a Y-branch waveguide (1×2) optical switch 2 formed by using the thermo-optic waveguide device, and FIG. 12 is a cross section thereof.

The Y-branch waveguide (1×2) optical switch 2 is a thermo-optic switch obtained by forming a Y-branch waveguide 50 including the thermal separation groove 30 on the silicon substrate 10, by performing the optical waveguide forming process shown in FIGS. 2 to 4, using a photosensitive sol-gel resin, and then forming a Cr thin film on the Y-branch waveguide 50 by sputtering, to form the thin-film heater 40 by the photolithographic processing.

The Y-branch waveguide (1×2) optical switch 2 includes one input waveguide core 51 from which light enters, two output waveguide cores 52a and 52b from which the light is emitted, thin-film heaters 40a and 40b that selectively heat either one of the output waveguides 52a and 52b to exert the thermo-optic effect, and thermo separation grooves 30a, 30b, and 30c that prevent heat conduction to a non-heated core on the opposite side.

In the Y-branch waveguide (1×2) optical switch 2, by heating either one of the thin-film heaters 40a and 40b, the refractive index of the waveguide below the heated thin-film heater changes by the thermo-optic effect, and the light entered from the input waveguide core 51 is switched and emitted from the output waveguide core on the opposite side (non-heated side).

For example, if only the thin-film heater 40a is heated, the incident light from the input waveguide core 51 is emitted from the output waveguide core 52b on the non-heated side, since the refractive index of the waveguide corresponding to the thin-film heater 40a is changed due to the thermo-optic effect.

On the other hand, if only the thin-film heater 40b is heated, the incident light from the input waveguide core 51 is emitted from the output waveguide core 52a on the non-heated side, since the refractive index of the waveguide corresponding to the thin-film heater 40b is changed due to the thermo-optic effect.

When either one of the output waveguide cores 52a and 52b is heated, thermal diffusion to the waveguide core on the opposite side (non-heated side) and the non-heated area (for example, heat conduction to an adjacent waveguide when a plurality of optical waveguide devices are arranged in parallel) is prevented by providing the thermo separation grooves 30a, 30b, and 30c.

For example, when only the thin-film heater 40a is heated, the heat thereof is transmitted to the corresponding output waveguide core 52a. However, since the thermo separation groove 30b is provided between the output waveguide cores 52a and 52b, direct heat conduction from the thin-film heater 40a to the output waveguide core 52b is effectively prevented.

The other thermo separation grooves 30a and 30c are effective to prevent the thermal diffusion from the thin-film heater 40a to the non-heated area.

Similarly, when only the thin-film heater 40b is heated, the heat thereof is transmitted to the corresponding output waveguide core 52b. However, since the thermo separation groove 30b is provided between the output waveguide cores 52a and 52b, direct heat conduction from the thin-film heater 40b to the output waveguide core 52a is effectively prevented.

The other thermo separation grooves 30a and 30c are effective to prevent the thermal diffusion from the thin-film heater 40b to the non-heated area.

Accordingly, the heat transmitted from the thin-film heaters 40a and 40b is confined inside the corresponding waveguide. As a result, an optical switch with low power consumption can be realized by heating only one of the output waveguide cores 52a and 52b, which is an object to be heated.

Since the heated range of the waveguide is narrowed by the thermo separation grooves 30a, 30b, and 30c, to reduce the heat capacity required for temperature rise of the thin-film heaters 40a and 40b, a high speed optical switch can be realized.

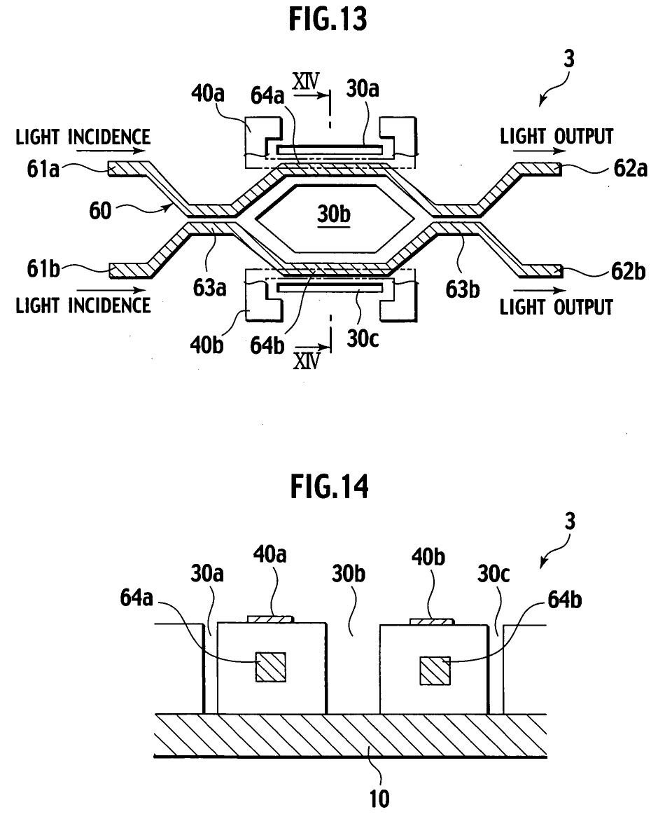

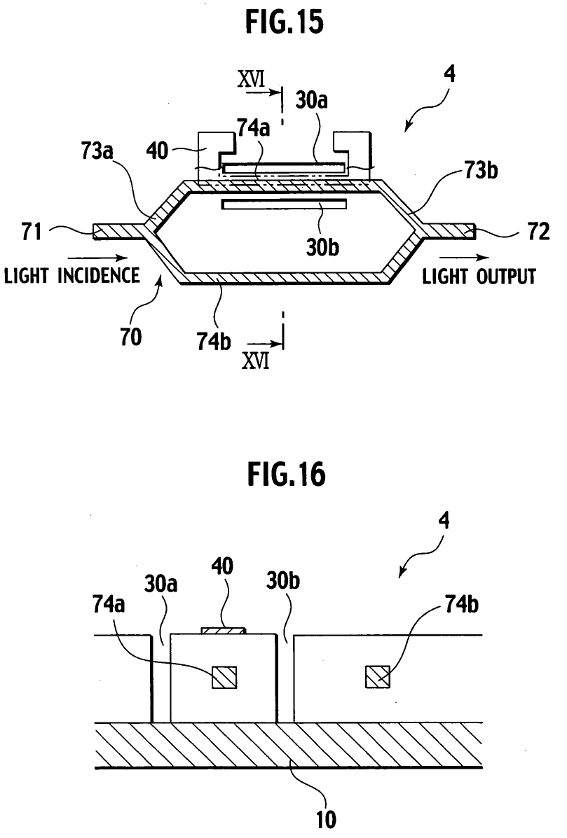

FIGS. 13 and 14 show a thermo-optic waveguide device according to a third embodiment of the present invention. FIG. 13 is a plan view of a Mach-Zehnder (MZ) interference (2×2) optical switch 3 formed by using the thermo-optic waveguide device, and FIG. 14 is a cross section thereof.

The Mach-Zehnder (MZ) interference (2×2) optical switch 3 is obtained by forming a MZ interference waveguide 60 including the thermo separation groove 30 on the silicon substrate 10 by executing the optical waveguide forming process shown in FIGS. 2 to 4 using a photosensitive sol-gel resin, and then forming a Cr thin film on the MZ interference waveguide 60 by sputtering to form the thin-film heater 40 by the photolithographic processing.

The Mach-Zehnder (MZ) interference (2×2) optical switch 3 includes two input waveguide cores 61a and 6b from which light enters, two output waveguide cores 62a and 62b from which the light is emitted, 3 dB couplers 63a and 63b, interferometer arm waveguides 64a and 64b, the thin-film heaters 40a and 40b that selectively heat either one of the interferometer arm waveguides 64a and 64b to exert the thermo optic effect, and the thermo separation grooves 30a, 30b, and 30c provided on the opposite sides of the interferometer arm waveguides 64a and 64b.

In the Mach-Zehnder (MZ) interference (2×2) optical switch 3, by heating either one of the thin-film heaters 40a and 40b provided on the interferometer arm waveguides 64a and 64b, the refractive index of the heated interferometer arm waveguide is changed due to the thermo-optic effect. Accordingly, a phase shift occurs in a propagated optical signal and an optical signal phase difference between the interferometer arm waveguides on the heated side and the non-heated side becomes 0 or 180 degrees, thereby switching the optical signal entering from the input waveguide cores 61a and 61b toward one of the output waveguide cores 62a and 62b and emitting the optical signal.

When either one of the interferometer arm waveguides 64a and 64b is heated, heat conduction to the interferometer arm waveguide on the opposite side is prevented by the thermo separation grooves 30a, 30b, and 30c provided on the opposite sides of the heated interferometer arm waveguides 64a and 64b. Consequently, the heated range is narrowed to either one of the interferometer arm waveguides 64a and 64b, which is an object to be heated, to reduce the heat capacity required for temperature rise of the thin-film heaters 40a and 40b. As a result, a high speed optical switch with low power consumption and low thermal stress can be realized.

FIGS. 15 and 16 show a thermo-optic waveguide device according to a fourth embodiment of the present invention. FIG. 15 is a plan view of a Mach-Zehnder (MZ) interference variable optical attenuator (VOA) 4 formed by using the thermo-optic waveguide device, and FIG. 16 is a cross section thereof.

The Mach-Zehnder (MZ) interference variable optical attenuator (VOA) 4 is obtained by forming a MZ interference waveguide 70 including the thermo separation groove 30 on the silicon substrate 10 by executing the optical waveguide forming process shown in FIGS. 2 to 4 by using a photosensitive sol-gel resin, and then forming a Cr thin film on the MZ interference waveguide 70 by sputtering, to form the thin-film heater 40 by the photolithographic processing.

The Mach-Zehnder (MZ) interference variable optical attenuator (VOA) 4 includes one input waveguide core 71 from which light enters, one output waveguide core 72 from which the light is emitted, Y-branch couplers 73a and 73b, interferometer arm waveguides 74a and 74b, the thin-film heater 40 that exerts a thermo-optic effect by heating only the interferometer arm waveguide 74a, and the thermo separation grooves 30a and 30b provided on the both sides of the interferometer arm waveguide 74a.

In the Mach-Zehnder (MZ) interference variable optical attenuator (VOA) 4, since the thin-film heater 40 provided on the interferometer arm waveguide 74a is heated, the refractive index of the heated interferometer arm waveguide 74a is changed due to the thermo-optic effect. Accordingly, a phase shift occurs in the transmitted optical signal, and the output optical intensity changes at the output waveguide core 72 according to the heating temperature, due to a phase difference between the optical signal that propagates in the heated interferometer arm waveguide 74a and the optical signal that propagates in the non-heated interferometer arm waveguide 74b.

When the interferometer arm waveguide 74a is heated, the heat conduction to the interferometer arm waveguide 74b on the opposite side (non-heated side) is prevented by the thermo separation grooves 30a and 30b provided on the opposite sides of the interferometer arm waveguide 74a to be heated. Furthermore, the heated range is narrowed to only the interferometer arm waveguide 74a, which is the object to be heated, thereby reducing the heat capacity required for temperature rise of the thin-film heater 40, and simultaneously, reducing the thermal stress generated by thermal expansion of the material. As a result, a high-speed optical VOA with low power consumption and low thermal stress can be realized.

The present invention is not limited to the above embodiments, and various modifications are possible. For example, when the waveguide core is not linear but in other optional shapes such as an R-curved shape, the shape of the thermal separation groove can be formed in other optional shapes such as the R-curved shape, along the shape of the waveguide core.

Furthermore, the scope of the thermo-optic waveguide device including the thermal separation groove according to the present invention is not limited to the one shown in the above embodiments. That is, the thermo-optic waveguide device including the thermal separation groove can be applied to various optical sensors, in addition to the optical switch and the variable optical attenuator.

As described above, according to the present invention, the thermo-optic waveguide device including, on the substrate, the optical waveguide and the thin-film heater that exerts the thermo-optic effect on the optical waveguide, includes the thermal separation groove arranged substantially in parallel with the optical waveguide core along at least one side of the optical waveguide core corresponding to the thin-film heater. As a result, the heat applied to the thin-film heater is used for temperature rise of the corresponding optical waveguide core, to realize low power consumption of the optical devices, and increase the switching speed of the optical devices. Furthermore, the polarization dependency and the extinction ratio of the optical devices are improved by the reduction of the thermal expansion stress, thereby realizing a high-performance optical device.

Furthermore, the optical waveguide and the thermal separation groove are simultaneously formed with high precision by simple manufacturing processes, without requiring expensive machining equipment, thereby realizing the thermo-optic waveguide device excellent in mass-productivity at a low cost.

Particularly, by applying the thermo-optic waveguide device to an optical communication system, for which low cost and low power consumption are required, it can be expected to contribute to the popularization of the optical communication system.

While preferred embodiments of the present invention have been described above, the foregoing description is in all aspects illustrative. It is therefore understood that numerous modifications can be devised without departing from the spirit or scope of the appended claims of the invention.

What is claimed is:

1. A thermo-optic waveguide device including, on a substrate, an optical waveguide and a thin-film heater that exerts a thermo-optic effect on the optical waveguide, comprising:
a thermal separation groove arranged substantially in parallel with an optical waveguide core along at least one side of the optical waveguide core corresponding to the thin-film heater.

2. The thermo-optic waveguide device according to claim 1, wherein the thermal separation groove is formed with a depth in which a surface of the substrate is exposed substantially.

3. The thermo-optic waveguide device according to claim 2, wherein the thermal separation groove is formed on the substrate together with the optical waveguide, by using a photopolymer capable of patterning by photolithographic processing.

4. A thermo-optic waveguide device including, on a substrate, a plurality of selectable optical waveguides and a thin-film heater that exerts a thermo-optic effect selectively on these optical waveguides, comprising:
a thermal separation groove arranged along an optical waveguide core corresponding to the thin-film heater, in an area between the optical waveguide cores, in a branch section where the optical waveguide is substantially branched to at least two optical waveguides.

5. The thermo-optic waveguide device according to claim 4, wherein the thermal separation groove is formed with a depth in which a surface of the substrate is exposed substantially.

6. The thermo-optic waveguide device according to claim 5, wherein the thermal separation groove is formed on the substrate together with the optical waveguide, by using a photopolymer capable of patterning by photolithographic processing.

7. A thermo-optic waveguide device including, on a substrate, an optical waveguide and a thin-film heater that exerts a thermo-optic effect on the optical waveguide, comprising:
a thermal separation groove having a depth in which a surface of the substrate is exposed substantially, and arranged near an optical waveguide core corresponding to the thin-film heater.

8. The thermo-optic waveguide device according to claim 7, wherein the thermal separation groove is formed on the substrate together with the optical waveguide, by using a photopolymer capable of patterning by photolithographic processing.

9. A manufacturing method of a thermo-optic waveguide device including, on a substrate, an optical waveguide and a thin-film heater that exerts a thermo-optic effect on the optical waveguide, wherein
in a process of forming the optical waveguide by using a photopolymer on a substrate, a thermal separation groove to be arranged near an optical waveguide core is formed together with the optical waveguide.

10. A manufacturing method of a thermo-optic waveguide device including, on a substrate, an optical waveguide and a thin-film heater that exerts a thermo-optic effect on the optical waveguide, comprising at least:
a process of forming a lower cladding layer including a thermal separation groove by applying a photopolymer for cladding on the substrate and by performing photolithographic processing where the thermal separation groove arranged substantially in parallel with an optical waveguide core corresponding to the thin-film heater is patterned along the optical waveguide core.

11. A manufacturing method of a thermo-optic waveguide device including, on a substrate, an optical waveguide and a thin-film heater that exerts a thermo-optic effect on the optical waveguide, comprising at least:
a process of forming a lower cladding layer including a thermal separation groove by applying a photopolymer for cladding on the substrate and by performing photolithographic processing where the thermal separation groove arranged substantially in parallel with an optical waveguide core corresponding to the thin-film heater is patterned along the optical waveguide core;
a process of forming the core by applying a photopolymer for the core on the lower cladding layer and by performing photolithographic processing where the core is patterned; and
a process of forming an upper cladding layer including the thermal separation groove by applying a photopolymer for cladding on the lower cladding layer and the core, and by performing photolithographic processing where the thermal separation groove is patterned.

12. A manufacturing method of a thermo-optic waveguide device including, on a substrate, an optical waveguide and a thin-film heater that exerts a thermo-optic effect on the optical waveguide, comprising:
a process of forming a lower cladding layer including a thermal separation groove by applying a photopolymer for cladding on the substrate and by performing photolithographic processing where the thermal separation groove arranged substantially in parallel with an optical waveguide core corresponding to the thin-film heater is patterned along the optical waveguide core;
a process of forming the core by applying a photopolymer for the core on the lower cladding layer and by performing photolithographic processing where the core is patterned;
a process of forming an upper cladding layer including the thermal separation groove by applying a photopolymer for cladding on the lower cladding layer and the core, and by performing photolithographic processing where the thermal separation groove is patterned; and
a process of forming the thin-film heater on the optical waveguide including the thermal separation groove.

13. The manufacturing method of a thermo-optic waveguide device according to claim 12, further comprising:
a process of forming a coupling layer for increasing adhesiveness between the substrate and the lower cladding layer, before the process of forming the lower cladding layer.
